(19) United States
(12) Patent Application Publication
(10) Pub. No.: US 2010/0086707 A1
(43) Pub. Date: Apr. 8, 2010

(54) Artificial attachment for vegetation

(76) Inventor: Réjean Boyer, Laval (CA)

Correspondence Address: Franz BONSANG;c/o EQUINOX PROTECTION, 410 - 1500, Du College, St-Laurent, QC, H4L 5G6, CA

(21) Appl. No.: 12/588,059

(22) Filed: Oct. 2, 2009

Related U.S. Application Data
(60) Provisional application No. 61/136,792, filed on Oct. 3, 2008.

(51) Int. Cl. A01N 1/00; B32B 3/10; A41G 1/00

(52) U.S. Cl. 428/16; 428/131; 428/136; 428/17

(57) ABSTRACT

An artificial attachment includes a ‘figure-of-eight’ slot, or similar shape, which upon flexure permits clamping application to vegetation or rod member, for example a twig, thereby to effect attachment thereto upon reflexure to its original shape.

### CROSS-REFERENCE TO RELATED APPLICATION

Benefit of U.S. Provisional Application for Patent Ser. No. 61/136,792, filed on Oct. 3, 2008, is hereby claimed.

### FIELD OF THE INVENTION

The present invention relates to an artificial attachment for use in attaching a synthetic element to vegetation or rod member. For example, the element may be in the form of a piece of foliage and the vegetation may be for example stems, stalks, twigs and the like, the combination creating a decorative effect. Such vegetation or rod member may be living or non-living.

The present invention has further reference to an artificial attachment for use in attaching a synthetic element to vegetation, wherein the synthetic element is a part of for example an entomological creature and a combination of such elements creates an artificial representation of the creature. Other creatures, animals or insects may be composed using specially formed synthetic elements according to the invention.

In a still further proposal of the invention the synthetic element is a part of a well-known character, a combination of parts representing the complete character, for example a cartoon character. Other applications of the present invention include but are not limited to miniature houses, mobile structures etc.

### BACKGROUND OF THE INVENTION

The production of artificial flowers and arrangements thereof has existed for many years and embraces a wide field extending from children's toys to artificial flower structures including co-ordinated floral arrangement assemblies, and to kits for creating for example easy care-free instant yard beautification.

One such kit is disclosed in U.S. Pat. No. 6,861,108 to Potoroka who proposes various means of attaching artificial flowers and foliage to stems or stalks, such means including inter alia pins, clips or ties or any combination thereof. A disadvantage of such attachment means is that they are separate from the particular piece of foliage requiring attachment and further such small attachment means represent a hazard for children.

Accordingly, there is a need for an improved artificial attachment to enable and facilitate the attachment of synthetic elements to vegetation or rod member.

### SUMMARY OF THE INVENTION

It is therefore a general object of the present invention to provide an improved artificial attachment for vegetation or rod member.

A further object of the present invention is to provide such an artificial attachment that is integral therewith, therefore affording an advantage in terms of a unitary piece.

A still further object of the present invention is to provide an artificial attachment for attaching a synthetic element to vegetation directly without the need to thread the element onto the vegetation.

According to the invention there is provided an artificial attachment formed integrally in a synthetic element, the attachment comprising a slot providing an entry for an elongate member to which the synthetic element is to be attached, said slot providing along at least part of its marginal edges a clamping zone which upon flexure of the element is openable and upon release is closable to clamp and thereby attach the element to the elongate member.

The slot or slot means may advantageously be of ‘figure-of-eight’ shape providing enlarged and rounded end portions and a restricted middle portion at the clamping zone, the restricted middle portion may be of relatively narrow dimension in comparison to the end portions. An alternative shape for the slot means may be an ‘hourglass’ shape and thus similar to the figure-of-eight shape giving a restricted middle portion for the clamping zone widening into the end portions.

Other alternative forms of slot may be employed and may be constituted by two spaced-apart apertures connected by a slit in the element the slit defining the clamping zone. The length of the slit may be of a size predetermined by the magnitude of the foliage to which the element is to be attached.

The synthetic element may conveniently be in the form of foliage, e.g. a leaf.

In the alternative, the synthetic element may be in the form of a representation of a part of an insect or other creature.

In a still further alternative, the synthetic element may be in the form of a part of famous characters, particularly cartoon characters, the assembled elements with the suitable vegetation combining to make the whole character.

Although the vegetation does not constitute a feature of the invention and generally will not be provided therewith when commercially available, it will usually consist of a twig, stem or stalk or similar element of relatively slender elongate form.

The invention may extend to a kit including but not limited to a plurality of flower parts, for example petals, stamens and other parts for assembly by interengagement one with the other by means of interleaving with a central opening of variable dimension for accommodating vegetation, such as generally represented by a twig, stem, stalk or similar element the end of which passes through the opening when assembly is completed, the whole to constitute an artificial flower. The kit would also include the synthetic element attachment herein described and claimed. Accordingly, a selection of synthetic elements may be included in the kit, for example leaves, insects parts and/or cartoon character parts. The object of providing such a kit would be to enable the user, for example a child, to create complete versions of flowers, insects, cartoon characters etc.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective front view of a synthetic element in the form of a leaf incorporating the artificial attachment of the present invention, the leaf being mounted on and attached to a piece of vegetation in the form of a twig;

FIG. 2 is a view of the leaf shown in FIG. 1 incorporating the attachment in accordance with an embodiment of the present invention;

FIG. 3 is a perspective scrap view 3 in FIG. 2 of the artificial attachment;

FIG. 4 is an enlarged perspective taken along line 3 of FIG. 2 shown in flexure with the attachment ready for application to the vegetation, viz. a twig also shown in this figure;

FIG. 5 is a perspective view of an assembled kit of synthetic elements attached to vegetation and combining to create a model of an animal, for example a dog; and

FIG. 6 is a diagrammatic representation of three different forms of slot means according to the invention.

### DETAILED DESCRIPTION OF THE PREFERRED EMBODIMENTS

With reference to the annexed drawings the preferred embodiment of the present invention will be herein described for indicative purpose and by no means as of limitation.

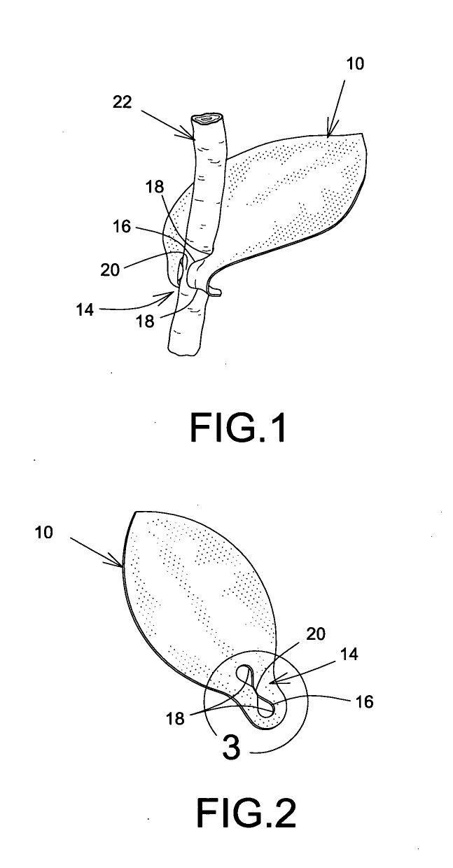

FIGS. 1 and 2 illustrate a synthetic element in the form of an ovate leaf 10 having at its root end an attachment referenced generally at 14 and comprising a slot 16 or slot means of ‘figure-of-eight’ shape with two end holes 18 separated by an open central clamping zone 20 of restricted dimension relative to the two holes 18. In FIG. 1 the leaf 10 is shown attached to a piece of vegetation or rod member in the form of a twig 22.

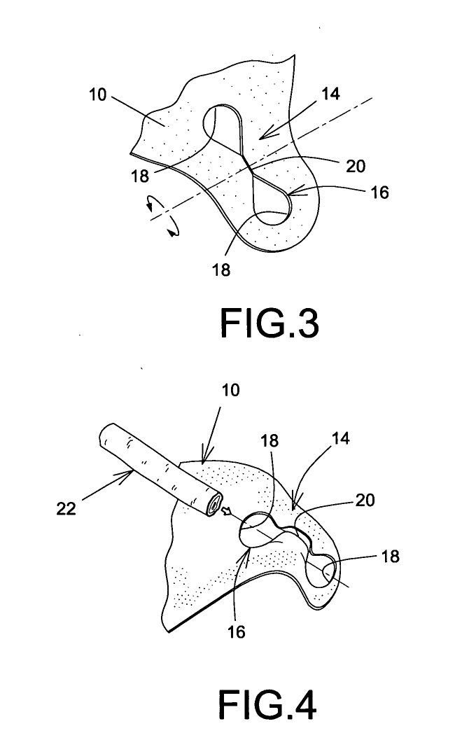

In FIGS. 3 and 4 the leaf 10 is shown in flexure, i.e. bent over in the region of the clamping zone 20 (as shown in FIG. 3), or slit, to give an opening for receiving vegetation in the form of the twig 22 of slender elongate form. In use, the application of the leaf 10 to the twig 22 is achieved by passing the twig 22 into the clamping zone 20 with the twig being accommodated in the end holes 18. The leaf 10 is then allowed substantially to reassume its unflexed state thus clamping the leaf to the twig 22. It will be appreciated that the attachment of the leaf to the twig is secured without the need to thread the leaf over the twig along its length to the desired position.

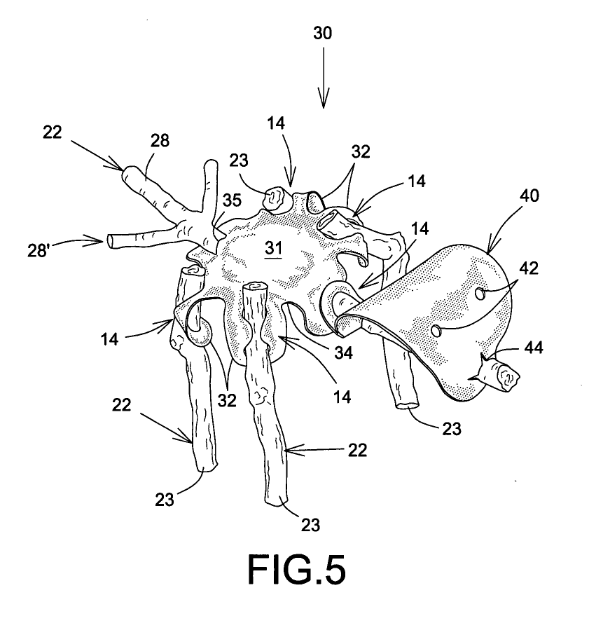

Referring now to FIG. 5, like parts have been assigned the same numerals of reference as used in the foregoing figures. This figure represents an animal 30 such as a dog having four legs 23 represented and constituted by pieces of vegetation, for example twigs 22 with a spinal column 28 also comprised of a twig 22 with a trifurcated rear end 28′, the legs and the column being conjoined by a synthetic element forming the main body part 31 of the dog 30. The main body part 31 of the dog 30 includes a number of attachment 14 shown engaging the legs 23, the application of the attachment 14 to the legs 23 being as previously described in relation to FIG. 4. The attachments 14 are formed in extensions 32 of the body part 31, adjacent extensions 32 being spaced apart as at 34. The body part 31 further has two holes 35, only one of which can be seen in the figure, longitudinally aligned therein to receive the spinal column 28 as shown. A head 40 for the dog is illustrated with two frontal apertures representing eyes 42, with an attachment 14 provided in the occipital region of the head to engage with and attach to the spinal column 28. A stellar-shaped hole 44 is formed at the front of the head 40 to depict the mouth of the dog and also to function in the assembly of the kit parts to receive the end of the spinal column 28.

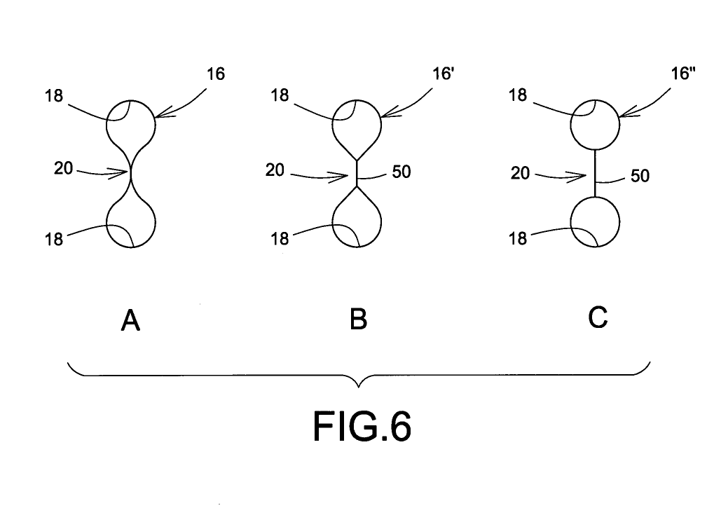

Referring now to FIG. 6, the three representations of the slot are designated A, B and C. ‘A’ shows a ‘figure-of-eight’ formation 16, whilst ‘B’ shows a slot 16′ comprising the holes 18 interconnected by a slit 50 merging into the holes. ‘C’ illustrates a slot 16″ comprising holes 18 interconnected by a longer slit 50 than that of ‘B’, the clamping zone thus being sharper than for ‘A’ and ‘B’. The particular type of slot selected will depend upon the materials and the manufacturing techniques being employed.

The synthetic elements may be made of plastics material that may be recyclable, as indeed may the other parts, which may be commercially available as a kit.

The present invention may be utilized in all manner of applications in which synthetic elements are combined to create an artificial representation of real flora or fauna, insects, cartoon characters or indeed other structures.

The invention may be provided for use by children in view of its inherent safety, in terms of it obviating the need for several separate and potentially dangerous parts. In the alternative, the invention may be available for adult usage in terms of creating an artificial effect of natural growth giving colour and form to an otherwise drab environment.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. An artificial attachment formed integrally in a synthetic element and comprising a slot providing an entry for an elongate member to which the synthetic element is to be attached, said slot providing along at least part of its marginal edges a clamping zone which upon flexure of the element is openable and upon release is closable to clamp and thereby attach the element to the elongate member.

2. The attachment of claim 1, wherein said synthetic element is made of a flexible plastic.

3. The attachment of claim 1, wherein said slot is comprised of first and second holes separated by an openable slit extending from said first hole to said second hole, said first and second holes being sized and shaped for accommodating said elongate member.

4. The attachment of claim 3, wherein said slit being sized and shaped for passage of the elongate member therethrough with said elongate member extending through said first and second holes when said attachment is placed by said flexure in a flexed state and for extending substantially around and clamp the elongate member with said elongate member accommodated in said holes when said attachment is biased, by said release of said flexure in an unflexed state.

5. The attachment of claim 3, wherein said slit extends generally centrally between said first and second holes.

6. The attachment of claim 3, wherein said first and second holes are circular in shape.

7. The attachment of claim 3, wherein said slot is generally in the form of a notional figure eight.

8. The attachment of claim 3, wherein said first and second holes taper inwardly towards said slit.

9. The attachment of claim 1, wherein said element is configured as a representation of an element of flora.

10. The attachment of claim 1, wherein said element is configured as a representation of an element of fauna.

11. The attachment of claim 1, wherein said element is configured as a representation of a well-known character.

12. The attachment of claim 10, wherein said representation of an element of flora is a representation of a leaf, said attachment being disposed at a root end thereof.

13. The attachment of claim 1, wherein said element is configured as a representation of a part of an element of flora.

14. The attachment of claim 1, wherein said element is configured as a representation of a part of an element of fauna.

15. The attachment of claim 1, wherein said element is configured as a representation of a part of a well-known character.
